(19) United States
(12) Patent Application Publication
(10) Pub. No.: US 2019/0318333 A1
(43) Pub. Date: Oct. 17, 2019

(54) REAL-TIME NETWORK PROCESSING NUCLEUS

(71) Applicant: BANK OF AMERICA CORPORATION, Charlotte, NC (US)

(72) Inventors: Joseph Benjamin Castinado, North Glenn, CO (US); Charles Russell Kendall, Snoqualmie, WA (US)

(21) Appl. No.: 15/952,005

(22) Filed: Apr. 12, 2018

(51) Int. Cl. G06Q 20/16; H04L 29/06; G06Q 20/40

(52) U.S. Cl. CPC G06Q 20/16; H04L 9/0637; G06Q 20/40; H04L 63/10

(57) ABSTRACT

Embodiments of the invention are directed to a system, method, or computer program product for solving a computer batch processing problem by building and providing a real-time interaction hub for real-time resource distribution processing. The invention forms connectivity channels to entity and user systems to perform real-time network processing irrespective of legacy processing associated with the entities. In this way, the invention generates an inter-entity level real-time processing with system knowledge of legacy systems for processing and reconciliation. Furthermore, the invention, via the connectivity, provides an indication of the location of the resource distribution within the cycle of entity processing of the resource distribution.

### BACKGROUND

Currently processing of resource distribution is delayed. Time is required for resource verification, reconciliation, and distribution. Typically, an end of day batching and reconciliation processing is performed prior to resource allocation. As such a real-time network processing nucleus is desired.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for building and positioning a settlement process for real-time interactions that handle invoices, resource distributions, and use of links (such as Uniform Resource Locator (URL)) for approvals.

Currently upon resource transfers the resources are not distributed in real-time. Typically, a credit or indication of the transfer is posted, but requires and end of day batch processing transfer from one entity to the other to settle the resource distribution. This typically takes a day or more to complete. The invention solves this computer batch processing problem by building and providing a settlement processing hub for real-time interaction and resource distribution approval and settlement process.

Embodiments of the invention relate to systems, methods, and computer program products for real-time resource distribution communication channeling, the invention comprises: deploying private communication linkage between users and institutions associated with a resource distribution; communicating and confirming authorization of processing of the resource distribution as a real-time resource distribution; posting, for institution visualization, processing and clearance of the real-time resource distribution; identifying institution legacy system processing for each channel available for resource distributions at an institution; identifying the institution legacy system for the resource distribution at the institution and trigger processing of the resource distribution at the institution legacy system; and monitoring location of resource distribution within the institution legacy system processing and provide the institutions associated with the resource distribution visibility into location of processing.

In some embodiments, the invention further comprises storing information about the resource distribution, the real-time resource distribution, and the channel for dimensional reporting.

In some embodiments, the invention further comprises performing real-time processing of the resource distribution using Uniform Resource Locator (URL) for instant institution access to inter-level settlement.

In some embodiments, identifying institution legacy system processing for each channel available for the resource distribution further comprises identification of capabilities for real-time processing or end-of-day batch processing.

In some embodiments, the invention further comprises communicating with a block chain distributed network for confirmation of authorization and authentication of real-time processing for the resource distribution.

In some embodiments, institution legacy systems comprise systems at the institutions for processing resource distributions received via a specific channel, wherein the processing is determined on an individual institution and regulatory requirement basis.

In some embodiments, providing the institutions associated with the resource distribution visibility into location of processing further comprises generating a secure interface for accessing a contextual visual representation of the location of processing the resource distribution.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a real-time network processing system environment, in accordance with one embodiment of the present invention;

FIG. 2 provides a block diagram of a high-level real-time interaction flow environment, in accordance with one embodiment of the present invention;

FIG. 3 provides a high level process flow illustrating a decentralized block chain architecture, in accordance with one embodiment of the present invention;

FIG. 4 provides a high level process flow illustrating real-time network processing system environment resource distribution processing, in accordance with one embodiment of the present invention;

FIG. 5 provides a process map illustrating generation of a real-time interaction hub for real-time network processing, in accordance with one embodiment of the present invention; and

FIG. 6 provides a process map illustrating real-time resource distribution processing, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, as used herein the term “user device” or “mobile device” may refer to mobile phones, personal computing devices, tablet computers, wearable devices, and/or any portable electronic device capable of receiving and/or storing data therein.

An “account” is the relationship that a user has with an entity, such as a financial institution. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. “Resources” include accounts of the user and/or other property owned by the user. The resources may be associated with accounts or may be property that is not associated with a specific account. Examples of resources associated with accounts may be accounts that have cash or cash equivalents, or accounts that are funded with or contain property, such as safety despots box account that jewelry, a trust account that is funded with property, or the like. Examples of resources that may not be associated with accounts may be antiques in a user's home, jewelry in a user's home, or the like. “Funds” or “Available Balance” are a balance in an account that can be invested or withdrawn. For example, the funds may refer to a bank ledger balance minus the amount of any monetary checks in the process of collection. Funds may also be referred to as an available balance, a collected balance, good funds, and usable funds.

A “resource distribution” refers to any communication between a user and the financial institution channel or resource transfer. For example, a resource distribution may refer to a purchase of goods or services, a return of goods or services, a payment transaction, a credit transaction, lines of credit, automated teller machine (ATM) transaction, or other interaction involving a user's account. In the context of a financial institution, a resource distribution may refer to one or more of: a sale of goods and/or services, initiating an ATM or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A resource distribution may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

A resource distribution or resource interaction may also refer to a resource transfer between users and/or entities participating in and leveraging a settlement network operating in real or near real-time (e.g., twenty-four hours a day, seven days a week), wherein settlement of the interaction occurs at or very close in time to the time of the interaction. A real-time interaction may include a payment, wherein a real-time interaction system enables participants to initiate credit transfers, receive settlement for credit transfers, and make available to a receiving participant funds associated with the credit transfers in real-time, wherein the credit transfer may be final and irrevocable. Real-time interactions or payments provide marked improvements over conventional interaction clearing and payment settlement methods (e.g., automated clearing house (ACH), wire, or the like) which can require several hours, days, or longer to receive, process, authenticate a payment, and make funds available to the receiving participant which may, in total, require several back-and-forth communications between involved financial institutions. In some cases, conventional settlement methods may not be executed until the end of the business day (EOB), wherein payments are settled in batches between financial institutions.

Real-time interactions reduce settlement time by providing pre-authentication or authentication at the time of a requested interaction in order to enable instantaneous or near-instantaneous settlement between financial institutions at the time of the interaction, wherein resources or funds may be made immediately available to a receiving participant (i.e., payee) following completion of the interaction. Examples of real-time interactions include business to business interactions (e.g., supplier payments), business to consumer interactions (e.g., legal settlements, insurance claims, employee wages), consumer to business interactions (e.g., bill pay, hospital co-pay, payment at point-of-sale), and peer to peer (P2P) interactions (e.g., repayment or remittance between friends and family). In a specific example, a real-time interaction may be used for payment of a utility bill on the due date of the bill to ensure payment is received on-time and accruement of additional fees due to late payment is avoided. In another example, real-time interactions may be especially beneficial for small entities and users (e.g., small merchants/businesses) that may have a heavier reliance on short-term funds and may not prefer to wait days for transaction settlements.

Real-time interactions not only provide settlement immediacy, but also provide assurance, fraud reduction, and bank-grade security to payments due to the inherent nature of the payment and user authentication infrastructure. Further, real-time interactions may reduce payment processing costs due to the simplified nature of required communication when compared to conventional settlement methods. In some embodiments, real-time interaction systems further include information and conversation tools that financial institutions may utilize to enhance a settlement experience for participants.

“Block chain” as used herein refers to a decentralized electronic ledger of data records which are authenticated by a federated consensus protocol. Multiple computer systems within the block chain, referred to herein as “nodes” or “compute nodes,” each comprise a copy of the entire ledger of records. Nodes may write a data “block” to the block chain, the block comprising data regarding a transaction. In some embodiments, only miner nodes may write transactions to the block chain. In other embodiments, all nodes have the ability to write to the block chain. In some embodiments, the block may further comprise a time stamp and a pointer to the previous block in the chain. In some embodiments, the block may further comprise metadata indicating the node that was the originator of the transaction. In this way, the entire record of transactions is not dependent on a single database which may serve as a single point of failure; the block chain will persist so long as the nodes on the block chain persist. A “private block chain” is a block chain in which only authorized nodes may access the block chain. In some embodiments, nodes must be authorized to write to the block chain. In some embodiments, nodes must also be authorized to read from the block chain. Once a transactional record is written to the block chain, it will be considered pending and awaiting authentication by the miner nodes in the block chain.

A “block” as used herein may refer to one or more records of a file with each record comprising data for transmission to a server. In some embodiments, the term record may be used interchangeably with the term block to refer to one or more transactions or data within a file being transmitted.

A system leveraging a real-time interaction settlement network allows for an interaction, transaction, payment, or the like to be completed between participating parties (e.g., financial institutions and/or their customers) via an intermediary clearing house acting in the role of a neutral party. Participant accounts are held at the clearing house and administered by both the participant and the clearing house. In this way, the clearing house is able to transfer resources or funds between the participant accounts on behalf of the participants in order to settle interactions.

Currently upon resource transfers the resources are not distributed in real-time. Typically, a credit or indication of the transfer is posted, but requires and end of day batch processing transfer from one entity to the other to settle the resource distribution. This typically takes a day or more to complete. The invention solves this computer batch processing problem by building and providing a settlement processing hub for real-time interaction and resource distribution approval and settlement process.

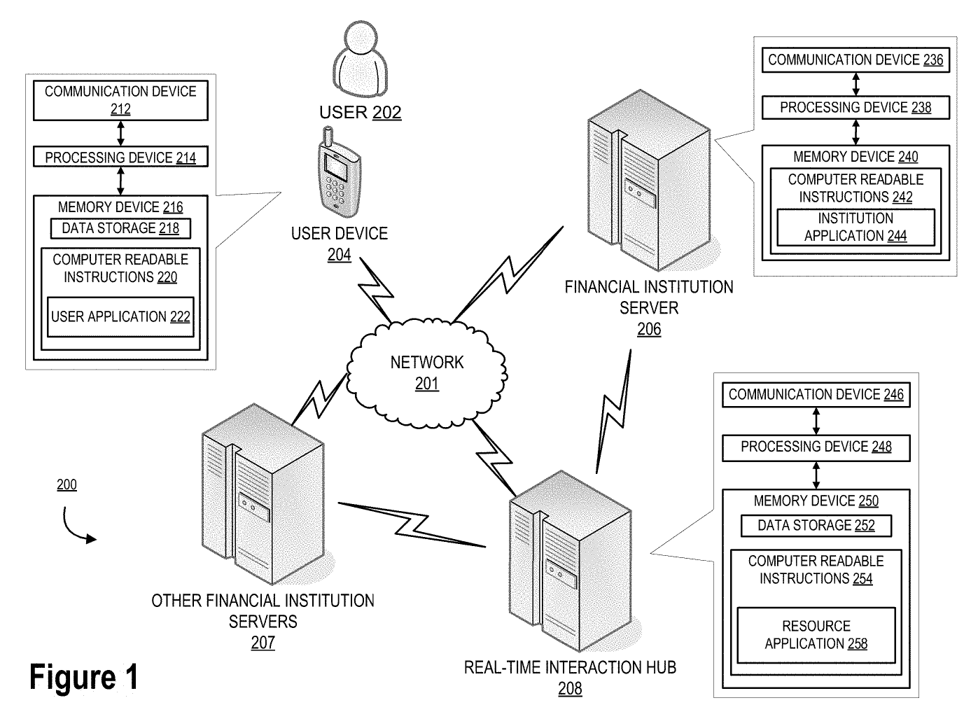

FIG. 1 illustrates a real-time network processing system environment 200, in accordance with one embodiment of the present invention. FIG. 1 provides the system environment 200 for which the distributive network system with specialized data feeds associated with the restrictive reallocation of resources system for building and positioning a settlement process for real-time interactions.

As illustrated in FIG. 1, the real-time interaction hub 208 is operatively coupled, via a network 201 to the user system 204, the financial institution server 206, and to other financial institution servers 207. In this way, the real-time interaction hub 208 can send information to and receive information from the user device 204, other financial institution servers 207, and the financial institution server 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual that has a user device, such as a mobile phone, tablet, or the like. FIG. 1 also illustrates a user system 204. The user device 204 may be, for example, a desktop personal computer, a mobile system, such as a cellular phone, smart phone, personal data assistant (PDA), laptop, or the like. The user device 204 generally comprises a communication device 212, a processing device 214, and a memory device 216. The user device 204 is a computing system that provide authentication for resource viewing and for interaction and manipulation of applications associated with resource management. The processing device 214 is operatively coupled to the communication device 212 and the memory device 216. The processing device 214 uses the communication device 212 to communicate with the network 201 and other devices on the network 201, such as, but not limited to the financial institution server 206, other financial institution servers 207, and the real-time interaction hub 208. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222.

In some embodiments, the user application 222 allows a user 202 to provide authentication for resource viewing via applications, receive contextual visual elements, and resource distribution, and resource reconciliation. In some embodiments, the user application 222 allows the user to sign onto or authenticate the double verification required for application access for withdrawing or transferring of resources.

As further illustrated in FIG. 1, the real-time interaction hub 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the financial institution server 206 and the user system 204. As such, the communication device 246 generally comprises a modem, server, or other device for communicating with other devices on the network 201.

As further illustrated in FIG. 1, the real-time interaction hub 208 comprises computer-readable instructions 254 stored in the memory device 250, which in one embodiment includes the computer-readable instructions 254 of a resource application 258. In some embodiments, the memory device 250 includes data storage 252 for storing data related to the system environment, but not limited to data created and/or used by the resource application 258.

In the embodiment illustrated in FIG. 1 and described throughout much of this specification, the resource application 258 may determine resource balances, process in real-time or near real-time resource distributions, and settle resource distributions in real-time or near real-time.

As illustrated in FIG. 1, the financial institution server 206 is connected to the real-time interaction hub 208 and is associated with a financial institution network. In this way, while only one financial institution server 206 is illustrated in FIG. 1, it is understood that multiple network systems may make up the system environment 200. The financial institution server 206 generally comprises a communication device 236, a processing device 238, and a memory device 240. The financial institution server 206 comprises computer-readable instructions 242 stored in the memory device 240, which in one embodiment includes the computer-readable instructions 242 of an institution application 244. The financial institution server 206 may communicate with the real-time interaction hub 208 for resource distribution. While the real-time interaction hub 208 may communicate with the financial institution server 206 via a secure connection generated for secure encrypted communications between the two systems for manipulating and transferring funds to one or more different resources.

As illustrated in FIG. 1, the other financial institution servers 207 are also connected to the real-time interaction hub 208 and is associated with other financial institution networks. In this way, while only one other financial institution servers 207 is illustrated in FIG. 1, it is understood that multiple network systems may make up the system environment 200. The other financial institution servers 207 generally comprises a communication device, a processing device, and a memory device. The other financial institution servers 207 may communicate with the real-time interaction hub 208 for resource distribution and settlement. While the real-time interaction hub 208 may communicate with the other financial institution servers 207 via a secure connection generated for secure encrypted communications between the two systems for manipulating and transferring funds to one or more different resources.

It is understood that the servers, systems, and devices described herein illustrate one embodiment of the invention. It is further understood that one or more of the servers, systems, and devices can be combined in other embodiments and still function in the same or similar way as the embodiments described herein.

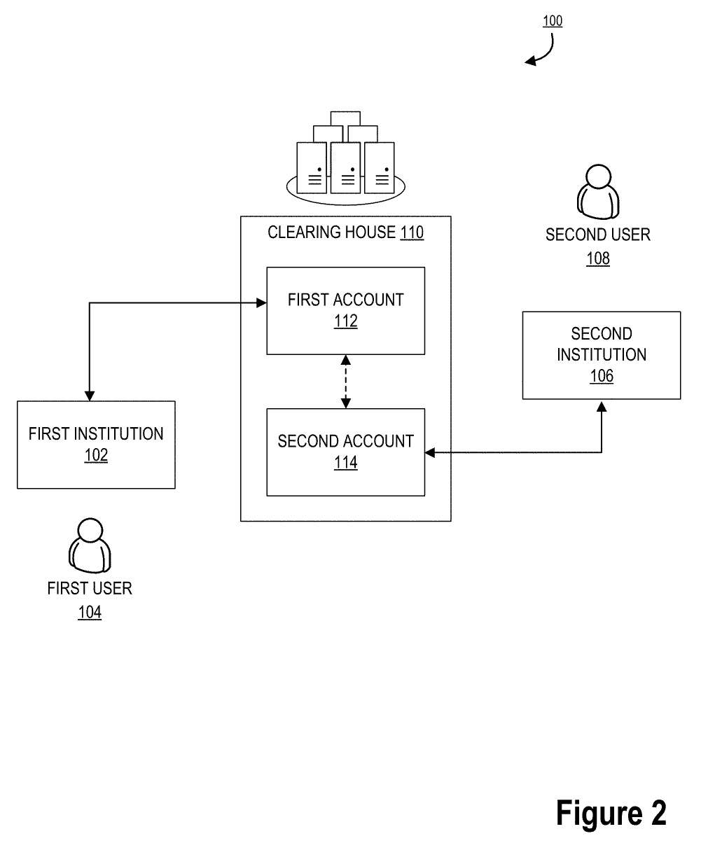

FIG. 2 illustrates a block diagram of a high-level real-time interaction flow environment 100, in accordance with one embodiment of the invention. In the illustrated environment, a first user 104 is associated with (i.e., a customer of) a first financial institution 102 and a second user 108 is associated with a second financial institution 106. A clearing house 110 comprises a first account 112 associated with the first financial institution 102 and a second account 114 associated with the second financial institution 106. The first account 112 and the second account 114 are accessible by each associated financial institution and the clearing house 110 which acts as a trusted intermediary during settlement between the financial institutions. Resources or funds may be transferred by each financial institution to and from their associated account. Transfers between the first account 112 and the second account 114 are administered by the clearing house 110 pending authentication and authorization by participating parties of each transfer.

In one embodiment, the first user 104 and the second user 108 are participants of a real-time interaction system, wherein the first user 104 (i.e., the payor) initiates a credit transfer to the second user 108 (i.e., the payee). In a specific example, the first user 104 is required to initiate the transfer from the first financial institution 102, wherein the first user 104 provides authentication information to authenticate the identity of the first user 104 and to validate that an account of the first user 104 held at the first financial institution 102 contains at least a sufficient amount of available funds to fulfill the transfer. While in one embodiment, the first user 104 is required to initiate the transfer from a physical, brick-and-mortar location of the first financial institution 102, in alternative embodiments described herein, the transfer may be initiated from other locations wherein a user is not required to be at a brick-and-mortar location (e.g., via an electronic application, a website, or the like).

The first user 104, as the sending participant (i.e., payor), is required to authenticate his or her identity by providing information or credentials to the associated financial institution. For example, authentication information may include account numbers, routing numbers, PIN numbers, username and password, date of birth, social security number, or the like, or other authentication information as described herein. In some embodiments, authentication may comprise multi-factor or multi-step authentication in accordance with information security standards and requirements.

Upon initiating an interaction, the first user 104 becomes obligated to pay the amount of the interaction, wherein the interaction cannot be canceled by the first user 104 following initiation and transmission of communication to a receiving participant. The second user 108, as the receiving participant (i.e., the payee), receives communication to accept payment following similar user authentication requirements. Communication between participants for the interaction is transmitted between the financial institutions via the clearing house 110 which directs the payment to the appropriate financial institution associated with the receiving participant. The transfer of funds occurs between the financial institution accounts 112 and 114 associated with the financial institutions 102 and 106 on behalf of their associated users, wherein the interaction may be settled immediately, concurrent with the interaction. As settlement occurs between the representative financial institutions, debiting and crediting of individual user accounts may be managed at each financial institution with their associated customers. As the interaction is settled immediately, funds may be made available for use in real or near real-time.

It should be understood that while the illustrated embodiment of FIG. 2 depicts only first and second users, financial institutions, and accounts, other embodiments of a real-time interaction network may comprise a plurality of accounts associated with a plurality financial institutions. In some embodiments, the environment 100 may further comprise more than one clearing house 110 (e.g., TCH, the Federal Reserve, and the like) that receive and process interaction requests as described herein. Financial institutions may include one or more community banks, regional banks, credit unions, corporate banks, direct connect financial institutions, and the like.

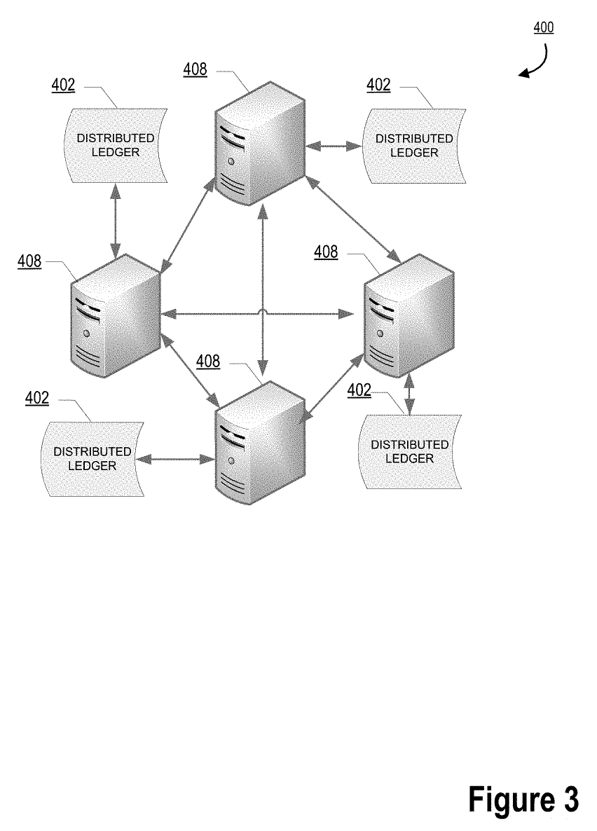

In some embodiments, a block chain system is utilized for user registration of accounts and authentication for utilization of the real-time interaction hub. As such, allowing for authentication of a user in a mobile or virtual resource distribution. The block chain may not comprise resource, but instead comprise account and authentication into the account for any real-time resource distribution. In this way, rather than utilizing a centralized database of data for instrument conversion, various embodiments of the invention may use a decentralized block chain configuration or architecture 400, as shown in FIG. 3 in order to facilitate the validation or failure location identification for file transmission. Such a decentralized block chain configuration ensures accurate mapping and tagging of blocks within a files during or after the transmission. Accordingly, a block chain configuration may be used to maintain an accurate ledger of files and the processing of transmission of the files by generation of a hash building of one or more blocks for each file of the transmission. In this way, building a traceable and trackable historic view of each file transmission for failure location identification.

A block chain is a distributed database that maintains a list of data blocks, such as real-time resource availability associated with one or more accounts or the like, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies. The data blocks recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. As such, the status of the instrument and the resources associated therewith can be validated and cleared by one participant.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. In some embodiments, the block chain system is closed, as such the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria.

A block chain system 400 is typically decentralized—meaning that a distributed ledger 402 (i.e., a decentralized ledger) is maintained on multiple nodes 408 of the block chain 400. One node in the block chain may have a complete or partial copy of the entire ledger or set of transactions and/or blocks on the block chain. The distributed ledger may comprise one or more account information, authentication information, and the like for the first and/or second user for verification and access to accounts for real-time resource distribution. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains. In some embodiments, the nodes 408 of the system might be financial institutions that function as gateways for other financial institutions. For example, a credit union might hold the account, but access the distributed system through a sponsor node.

Various other specific-purpose implementations of block chains have been developed. These include distributed domain name management, decentralized crowd-funding, synchronous/asynchronous communication, decentralized real-time ride sharing and even a general purpose deployment of decentralized applications. The system may comprise at least one or more nodes used to generate blocks and process hashing within file transmission for transmission validation or failure location identification during file transfers across servers.

Furthermore, in some embodiments, a plurality of computer systems are in operative networked communication with one another through a network. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between devices on the network.

In some embodiments, the computer systems represent the nodes of the private block chain, such as the miner node or the like. In such an embodiment, each of the computer systems comprise the private block chain, providing for decentralized access to the block chain as well as the ability to use a consensus mechanism to verify the integrity of the data therein. In some embodiments, an upstream system and a downstream system are further operatively connected to the computer systems and each other through the network. The upstream system further comprises a private ledger and the private block chain. The downstream system further comprises the private block chain and an internal ledger, which in turn comprises a copy of the private ledger.

In some embodiments, a copy of private block chain may be stored on a durable storage medium within the computer systems or the upstream system or the downstream system. In some embodiments, the durable storage medium may be RAM. In some embodiments, the durable storage medium may be a hard drive or flash drive within the system.

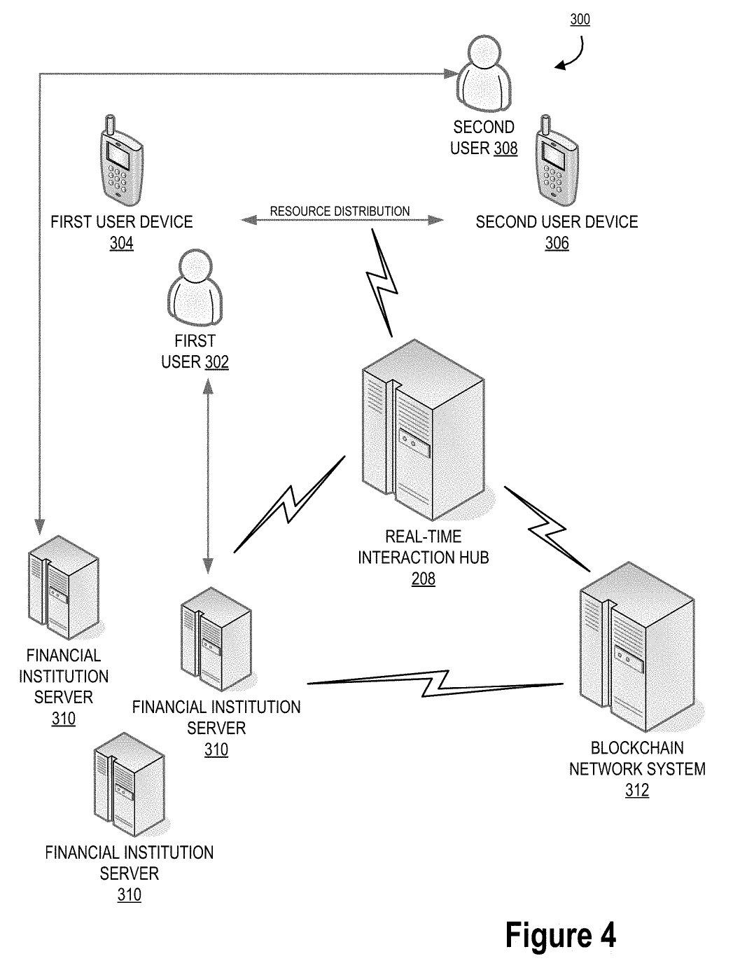

FIG. 4 provides a high level process flow illustrating real-time network processing system environment resource distribution processing 300, in accordance with one embodiment of the present invention. FIG. 4 illustrates the real-time network processing for settlement of resource distributions in real time. In this way, the system may identify a first user 302 with a first user device 304 making a resource distribution, such as purchasing a product, service, or the like from the second user 308 associated with a second user device 306. The system may identify the first user 302 as being associated with a financial institution and transfer the resources immediately to the financial institution associated with the second user 308, via the financial institution servers 310. The immediate transfer requires authentication, as such the first user 302 may be completing the resource distribution in person or digitally at the merchant or second user 308 location.

The real-time interaction hub 208 identifies the resource distribution ties old and new technology together to allow for real-time settlement of the resource distribution. The real-time interaction hub 208 identifies a transaction and positions a settlement process for real-time interactions that handle invoices, resource distributions, and use of links, URL, or the like for approvals. The real-time interaction hub 208 immediately lodges the entry of the resource distribution at the federal level for resource reserves and various financial institutions in real-time such that each has access to the settlement of the resource distribution in real-time. In this way, the real-time interaction hub 208 creates a real-time settlement at an inter-financial institution level. Thus eliminating batch processing and reconciliation, but instead providing immediate settlement of the resource transaction. The real-time interaction hub 208 posts the resource distribution to the block chain network system 312. The block chain network system 312 stores information of the user accounts and the authentication credentials for the user account on the block chain systems.

In this way, each individual financial institution server 310, is not required to change or modify their settlement process, which typically includes a bundling and performing off hour settlement of the day's resource distributions. A financial institution server 310 may be associated with a first user 302 and a second user 308. Each user may be associated with the same financial institution server 310 or a different financial institution server. Each financial institution server 310 may be in communication with the real-time interaction hub 208. The real-time interaction hub 208 may identify the resource distribution and the channel associated with the resource distribution, such as credit, debt, account, check, line-of-credit, or the like. Each of these channels may be siloed with respect to settlement and may require hard or soft settlement periods that are different. The real-time interaction hub 208 may transfer resources within the real-time interaction hub 208 to illustrate real-time settlement, but still allow for processing through legacy settlement procedure for that channel.

The real-time interaction hub 208 may keep track of all real-time resource distributions and track the legacy investment systems associated with the financial institutions and know which resource distributions were cleared during the day and which were soft posted or memo posted that requires end of day hard posting. As such, the real-time interaction hub 208 doesn't need a 24-hour period for various resource distribution hard postings, but instead recognized the legacy systems with the financial institution and which may accept intra-day postings. The real-time interaction hub 208 may communicate with new and legacy software programs and communicates to all interested parties the real-time location and state of resource distribution and clearance stage of those resource distributions.

Internally, the real-time interaction hub 208 allows for system identification of locations of resource transfers within the settlement process irrespective of channel of resource distribution. In this way, the real-time interaction hub 208 may identify the location and have real-time visibility to all location of resource distribution settlement for regulation compliance and reconciliation. Furthermore, the location of the resource distribution settlement may be transmitted to an interface for entity visualization to inform customers of the location of the resource transaction. In this way, the real-time interaction hub 208 may in real-time present the location of the resource distribution to an interface for real-time display of transaction location for customer reconciliation and visualization.

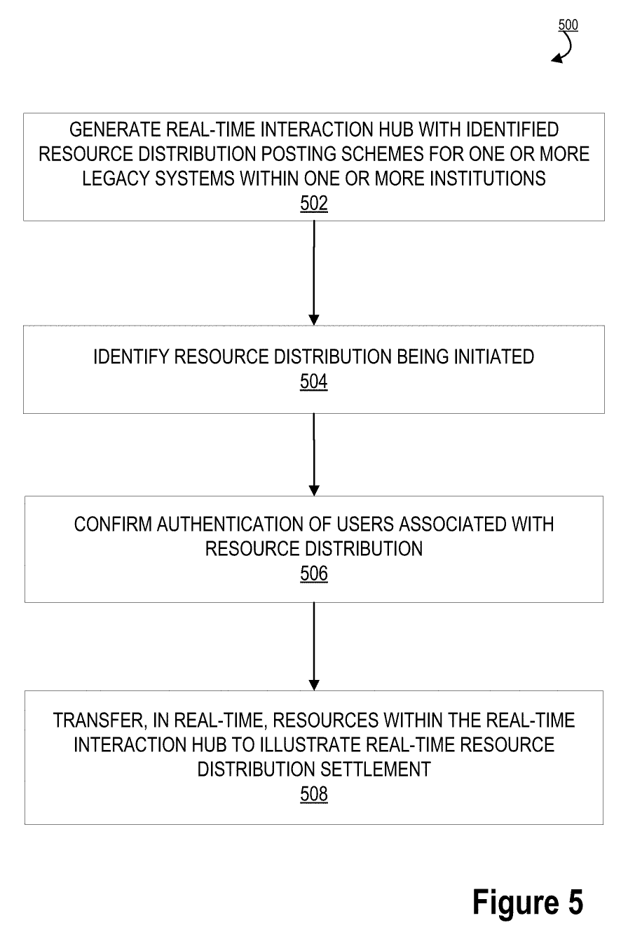

FIG. 5 provides a process map illustrating generation of a real-time interaction hub for real-time network processing 500, in accordance with one embodiment of the present invention. As illustrated in block 502, the process 500 is initiated by generation of the real-time interaction hub with identified resource distribution positing schemes for one or more legacy systems within one or more institutions. In this way, the system identifies the various resource distribution posting schemes for various channels for completion of a transaction. These may include debit cards, credit cards, lines of credit, contracts, loans, savings account, checking accounts, stock transactions, or the like. Each various channel has its own unique settlement processes for completing the resource distribution and settlement. In this way, each resource distribution channel requires a posting scheme for settlement of the resource distribution. Generating this information allows resource distribution institutions, such as financial institutions, to maintain their current legacy systems for settlement of each of the different resource distributions. As such, there may be multiple different silo systems for each different channel of distribution. In this way, the real-time interaction hub allows for the institutions to keep their current legacy systems, but still allows for real-time resource distribution processing. As such, the real-time interaction hub provides a unique process for real-time resource distribution without channel settlement process modification.

Next, as illustrated in block 504, the process 500 continues by identifying a resource distribution being initiated. This may be an in person transaction or a digital transaction using one or more channels for resource distribution between users or entities. The real-time interaction hub identifies the resource distribution being initiated based on user, financial institution, or entity notification based on the real-time interaction hub being networked within the various systems associated with the resource distribution.

As illustrated in block 506, the process 500 continues by confirming the authentication and authorization of the users associated with the resource distribution. In this way, the real-time interaction hub may communicate with the block chain distributed network. The block chain network may contain authentication and authentication information about the users for the resource distribution. In this way, the block chain network may identify authentication in real-time for the resource distribution for real-time settlement via the real-time interaction hub.

Next, as illustrated in block 508, the process 500 is completed by transferring, in real-time, resources within the real-time interaction hub to illustrate real-time resource distribution settlement. In this way, the real-time interaction hub identifies the type of settlement possible via the legacy system associated with the channel of the resource distribution. The real-time interaction hub may utilize that data to extract resources and apply resources appropriately for real-time appearance of completion of the resource distribution. Furthermore, the real-time interaction hub may monitor the processing and settlement via the legacy systems to identify completion of the resource distribution via the legacy system.

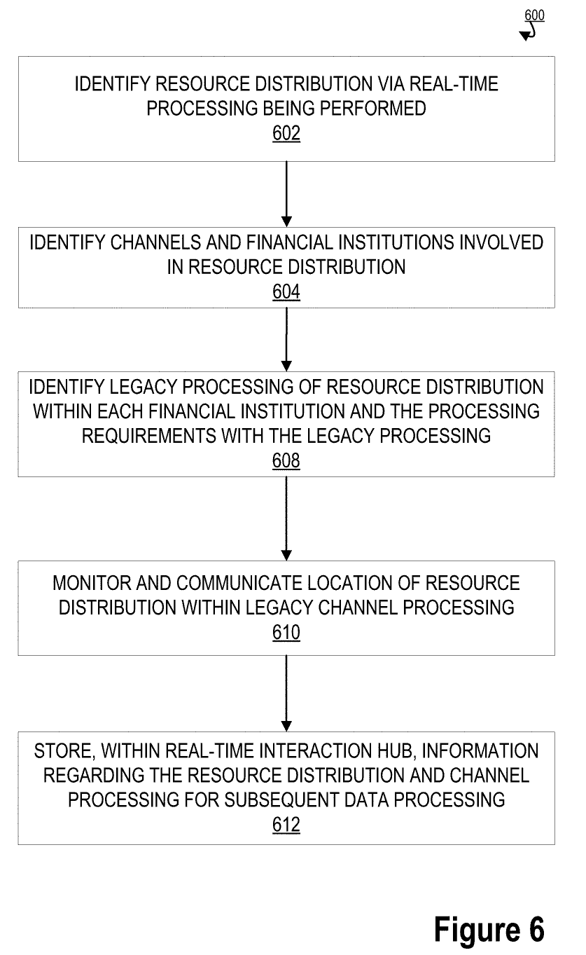

FIG. 6 provides a process map illustrating real-time resource distribution processing 600, in accordance with one embodiment of the present invention. As illustrated in block 602, the process 600 is initiated by identifying a resource distribution being initiated and confirm the authentication and authorization via the block chain network.

Next, as illustrated in block 604, the process 600 continues by identifying the channels and financial institutions involved in the resource distribution. The channels may include any resource distribution, such as via contract, a line of credit, transaction for a product or service using credit account, debit account, or the like. The financial institutions involved may include a federal institution and one or more financial institutions associated with the users involved in the resource distribution.

Upon identification of the resource distribution, the users associated with the resource distribution, the entities associated with the resource distribution, and the channel of the distribution, the system may extract and post the resources within the real-time interaction hub to illustrate the resource distribution. In this way, irrespective of the channel of the resource distribution or the legacy processing of the channel of the resource distribution, the real-time interaction hub may communicate a transfer of resources for the resource distribution to the interested financial institutions. Next, as illustrated in block 608, the process 600 continues by identifying the legacy processing program for the resource distribution channel within each financial institution and the processing requirements associated with that legacy processing program. In this way, each processing program is performed differently based on regulatory factors and individual entity requirements. As such, the real-time interaction hub doesn't inhibit the processing via the channel processing programs, the real-time interaction hub expedites the settlement for the parties involved in the resource distribution and provides visualization into the set the resource distribution is at within the financial institution processing.

As the legacy processing continues to process the resource distribution within the financial institutions associated with the resource distribution, the real-time interaction hub, via communication linkage, monitors the location of the transaction within the settlement process. As illustrated in block 610, the process 600 continues by the real-time interaction hub monitoring and communication the location of the resource distribution within the legacy channel processing. In this way, the real-time interaction hub may provide, via an interface and/or notification to the one or more users or entities associated with the resource distribution.

The information from the real-time interaction hub may be further analyzed to perform data analytics for generation of dimensional reporting of specific channel usages for categorization. In this way, as illustrated in block 612, the process 600 includes storing, within the real-time interaction hub, information regarding the resource distribution and channel processing for subsequent data processing and categorization.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent application | | |
|---|---|---|---|
| Docket Number | Ser. No. | Title | Filed On |
| 8333US1.014033.3188 | To be assigned | NETWORK AUTHENTICATION | Concurrently |
| | | FOR REAL-TIME INTERACTION | herewith |
| | | USING PRE-AUTHORIZATED | |
| | | DATA RECORD | |
| 8335US1.014033.3190 | To be assigned | REAL-TIME DATA PROCESSING | Concurrently |
| | | PLATFORM WITH INTEGRATED | herewith |
| | | COMMUNICATION LINKAGE | |
| 8336US1.014033.3191 | To be assigned | REAL TIME DATA PROCESSING | Concurrently |
| | | PLATFORM FOR RESOURCES | herewith |
| | | ON DELIVERY INTERACTIONS | |
| 8337US1.014033.3192 | To be assigned | INTERNET-OF-THINGS ENABLED | Concurrently |
| | | REAL-TIME EVENT PROCESSING | herewith |

What is claimed is:

1. A system for real-time resource distribution communication channeling, the system comprising:
a memory device with computer-readable program code stored thereon;
a communication device;
a processing device operatively coupled to the memory device and the communication device, wherein the processing device is configured to execute the computer-readable program code to:
deploy a private communication linkage between users and institutions associated with a resource distribution;
communicate and confirm authorization of processing of the resource distribution as a real-time resource distribution;
post, for institution visualization, processing and clearance of the real-time resource distribution;
identify institution legacy system processing for each channel available for resource distributions at an institution;
identify the institution legacy system for the resource distribution at the institution and trigger processing of the resource distribution at the institution legacy system; and
monitor a location of resource distribution within the institution legacy system processing and provide the institutions associated with the resource distribution visibility into location of processing.

2. The system of claim 1, further comprising storing information about the resource distribution, the real-time resource distribution, and the channel for dimensional reporting.

3. The system of claim 1, further comprising performing real-time processing of the resource distribution using Uniform Resource Locator (URL) for instant institution access to inter-level settlement.

4. The system of claim 1, wherein identifying institution legacy system processing for each channel available for the resource distribution further comprises identification of capabilities for real-time processing or end-of-day batch processing.

5. The system of claim 1, further comprising communicating with a block chain distributed network for confirmation of authorization and authentication of real-time processing for the resource distribution.

6. The system of claim 1, wherein institution legacy systems comprise systems at the institutions for processing resource distributions received via a specific channel, wherein the processing is determined on an individual institution and regulatory requirement basis.

7. The system of claim 1, wherein providing the institutions associated with the resource distribution visibility into location of processing further comprises generating a secure interface for accessing a contextual visual representation of the location of processing the resource distribution.

8. A computer program product for real-time resource distribution communication channeling, the computer program product comprising at least one non-transitory computer-readable medium having computer-readable program code portions embodied therein, the computer-readable program code portions comprising:
an executable portion configured for deploying a private communication linkage between users and institutions associated with a resource distribution;
an executable portion configured for communicating and confirming authorization of processing of the resource distribution as a real-time resource distribution;
an executable portion configured for posting, for institution visualization, processing and clearance of the real-time resource distribution;
an executable portion configured for identifying institution legacy system processing for each channel available for resource distributions at an institution;
an executable portion configured for identifying the institution legacy system for the resource distribution at the institution and trigger processing of the resource distribution at the institution legacy system; and
an executable portion configured for monitoring a location of resource distribution within the institution legacy system processing and provide the institutions associated with the resource distribution visibility into location of processing.

9. The computer program product of claim 8, further comprising an executable portion configured for storing information about the resource distribution, the real-time resource distribution, and the channel for dimensional reporting.

10. The computer program product of claim 8, further comprising an executable portion configured for performing real-time processing of the resource distribution using Uniform Resource Locator (URL) for instant institution access to inter-level settlement.

11. The computer program product of claim 8, wherein identifying institution legacy system processing for each channel available for the resource distribution further comprises identification of capabilities for real-time processing or end-of-day batch processing.

12. The computer program product of claim 8, further comprising an executable portion configured for communicating with a block chain distributed network for confirmation of authorization and authentication of real-time processing for the resource distribution.

13. The computer program product of claim 8, wherein institution legacy systems comprise systems at the institutions for processing resource distributions received via a specific channel, wherein the processing is determined on an individual institution and regulatory requirement basis.

14. The computer program product of claim 8, wherein providing the institutions associated with the resource distribution visibility into location of processing further comprises generating a secure interface for accessing a contextual visual representation of the location of processing the resource distribution.

15. A computer-implemented method for real-time resource distribution communication channeling, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
deploying a private communication linkage between users and institutions associated with a resource distribution;
communicating and confirming authorization of processing of the resource distribution as a real-time resource distribution;
posting, for institution visualization, processing and clearance of the real-time resource distribution;
identifying institution legacy system processing for each channel available for resource distributions at an institution;
identifying the institution legacy system for the resource distribution at the institution and trigger processing of the resource distribution at the institution legacy system; and
monitoring a location of resource distribution within the institution legacy system processing and provide the institutions associated with the resource distribution visibility into location of processing.

16. The computer-implemented method of claim 15, further comprising storing information about the resource distribution, the real-time resource distribution, and the channel for dimensional reporting.

17. The computer-implemented method of claim 15, further comprising performing real-time processing of the resource distribution using Uniform Resource Locator (URL) for instant institution access to inter-level settlement.

18. The computer-implemented method of claim 15, wherein identifying institution legacy system processing for each channel available for the resource distribution further comprises identification of capabilities for real-time processing or end-of-day batch processing.

19. The computer-implemented method of claim 15, further comprising communicating with a block chain distributed network for confirmation of authorization and authentication of real-time processing for the resource distribution.

20. The computer-implemented method of claim 15, wherein institution legacy systems comprise systems at the institutions for processing resource distributions received via a specific channel, wherein the processing is determined on an individual institution and regulatory requirement basis.
